(19) United States
(12) Patent Application Publication
(10) Pub. No.: US 2026/0318506 A1
(43) Pub. Date: Oct. 15, 2026

(54) LIGHTING FIXTURES COMPRISING ROTATABLE OPTICAL ASSEMBLIES

(71) Applicant: CREE LIGHTING USA LLC, Racine, WI (US)

(72) Inventors: Corey Goldstein, Milwaukee, WI (US); Kurt Wilcox, Libertyville, IL (US); Nathan R. Snell, Raleigh, NC (US)

(21) Appl. No.: 19/111,049

(22) PCT Filed: Sep. 12, 2022
(86) PCT No.: PCT/US2022/043215

§ 371 Date: Mar. 12, 2025

(51) Int. Cl. F21V 14/02; F21S 8/08; F21V 5/08; F21V 19/02; F21Y 105/16; F21Y 115/10

(52) U.S. Cl. CPC F21V 14/02; F21S 8/088; F21V 5/08; F21V 19/02; F21Y 2105/16; F21Y 2115/10

(57) ABSTRACT

In one aspect, lighting fixtures are described herein having the ability to provide multiple lighting distributions from a single architecture. Such lighting fixtures can be adjustable, thereby enabling the end user to select the desired lighting distribution. A lighting fixture, in some embodiments, comprises a support extending along an axis from a first end to a second end, and a lighting assembly coupled to the second end of the support. The lighting assembly comprises a light emitting face comprising a fixed optical assembly and a rotatable optical assembly, wherein the light emitting face faces the support, and lighting distribution of the lighting assembly varies according to rotational position of the rotatable optical assembly.

### FIELD

The present invention relates to lighting fixtures and, in particular, to lighting fixtures employing rotatable optical assemblies operable to provide a variety of adjustable lighting distributions.

### BACKGROUND

Lighting fixtures, such as sidewalk, roadway and/or parking lot fixtures, provide lighting distributions for meeting various areal lighting requirements. Lighting fixtures, for example, can provide a Type II distribution suitable for walkways, highway on-ramps and off-ramps as well as other long and narrow corridors. In other embodiments, lighting fixtures can provide a Type III distribution generally employed for roadway lighting and parking lots where a larger area of lighting is required. Alternatively, a Type V lighting distribution can be provided. Type V lighting distribution can be circular or square, having isotropic intensity over all lateral angles.

A significant disadvantage of existing lighting fixtures is the static nature of their design. Lighting fixtures are designed to provide a specific lighting distribution for a particular application. Once manufactured and installed, these fixtures lack adjustability and/or the ability to provide multiple lighting distributions according to multiple applications or functions. The lack of adjustability can require costly replacement of the fixtures due to changes in the lighting environment.

### SUMMARY

In view of the foregoing disadvantages, lighting fixtures are described herein having the ability to provide multiple lighting distributions from a single architecture. Such lighting fixtures can be adjustable, thereby enabling the end user to select the desired lighting distribution. A lighting fixture, in some embodiments, comprises a support extending along an axis from a first end to a second end, and a lighting assembly coupled to the second end of the support. The lighting assembly comprises a light emitting face comprising a fixed optical assembly and a rotatable optical assembly, wherein the light emitting face faces the support, and the lighting distribution of the lighting assembly varies according to rotational position of the rotatable optical assembly. In some embodiments, the lighting fixture provides an asymmetric lighting distribution. Alternatively, the lighting fixture may provide a symmetric or substantially symmetric lighting distribution.

In another aspect, a lighting assembly of a lighting fixture comprises a light emitting face including at least one rotatable optical assembly, wherein the lighting distribution of the lighting assembly varies according to rotational position of the rotatable optical assembly. In some embodiments, the lighting emitting face further comprises one or more fixed optical assemblies.

In another aspect, methods of lighting surfaces are described herein. A method, in some embodiments, comprises providing a lighting fixture including a support extending along an axis from a first end to a second end, and a lighting assembly coupled to the second end of the support, the lighting assembly having a light emitting face comprising a fixed optical assembly and a rotatable optical assembly, wherein the light emitting face faces the support. The rotational position of the rotatable optical assembly is adjusted to vary the lighting distribution directed to the surface by the lighting assembly. As described herein, the rotatable optical assembly can be adjusted to provide an asymmetric lighting distribution or a symmetric lighting distribution.

These and other embodiments are further described in the following detailed description.

### BRIEF DESCRIPTION OF THE DRAWINGS

FIG. 1 illustrates an elevation sectional view of a lighting fixture described herein according to some embodiments.

FIG. 2 illustrates a perspective view of the lighting assembly of FIG. 1.

FIG. 3 illustrates a cut-away sectional view of a lighting assembly and associated rotatable optical assembly according to some embodiments.

FIG. 4 illustrates an exploded view of a lighting assembly according to some embodiments.

FIG. 5 illustrates one embodiment where LED electronics are positioned in the support of the lighting fixture.

FIGS. 6A-6C illustrate one embodiment wherein the rotational position of the rotatable optical assembly is selected to provide a symmetric or substantially symmetric lighting distribution form the lighting assembly.

FIGS. 7A-7C illustrate one embodiment wherein the rotational position of the rotatable optical assembly is selected to provide an asymmetric lighting distribution form the lighting assembly.

FIG. 8 illustrates one embodiment wherein the fixed and rotatable optical assemblies are in a semi-concentric format in the plane of the light emitting face.

FIG. 9 illustrate lighting fixture with differing lighting distributions according to some embodiments.

FIG. 10 illustrates one embodiment of hard stops in the head space of the lighting assembly.

### DETAILED DESCRIPTION

Embodiments described herein can be understood more readily by reference to the following detailed description and examples and their previous and following descriptions. Elements, apparatus and methods described herein, however, are not limited to the specific embodiments presented in the detailed description and examples. It should be recognized that these embodiments are merely illustrative of the principles of the present invention. Numerous modifications and adaptations will be readily apparent to those of skill in the art without departing from the spirit and scope of the invention.

In one aspect, a lighting fixture comprises a support extending along an axis from a first end to a second end, and a lighting assembly coupled to the second end of the support. The lighting assembly comprises a light emitting face comprising a fixed optical assembly and a rotatable optical assembly, wherein the light emitting face faces the support, and lighting distribution of the lighting assembly varies according to rotational position of the rotatable optical assembly.

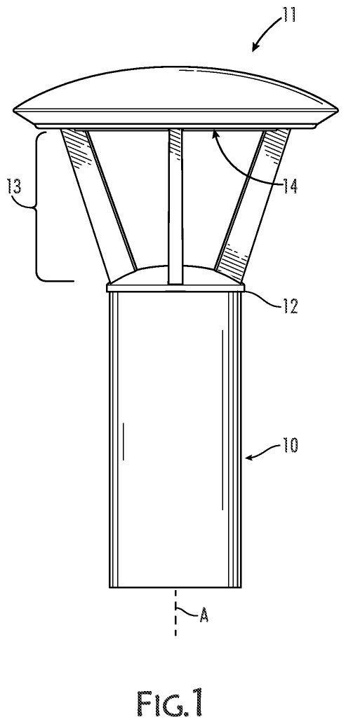

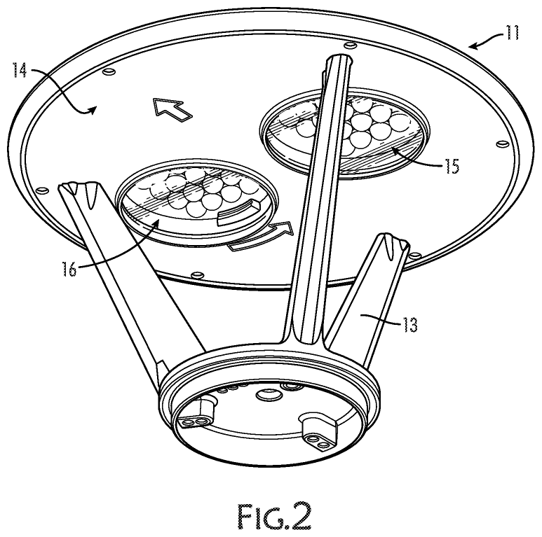

FIG. 1 illustrates an elevation sectional view of a lighting fixture described herein according to some embodiments. In the embodiment of FIG. 1, the lighting assembly 11 is coupled to the second end 12 of the support 10 via arms 13 extending in the vertical direction. The light emitting face 14 of the lighting assembly 11 faces the second end 12 of the support 10. The light emitting face 14 can direct light outside the diameter of the second end of the support 10, as described further herein. Moreover, the light emitting face 14 can be normal or substantially normal to the axis A of the support 10. FIG. 2 illustrates a perspective view of the light assembly 11 of FIG. 1. The light emitting face 14 comprises a rotatable optical assembly 15 and a fixed optical assembly 16. The rotatable optical assembly 15 can be rotatable in the plane of the light emitting face 14 or a plane parallel or substantially parallel to the light emitting face 14.

The rotatable optical assembly of lighting fixtures described herein can be radially adjusted according to any desired increment(s). In some embodiments, for example, the rotational position of the rotatable optical assembly is adjustable in at least one degree increments. Rotational position of the rotatable optical assembly can also be adjustable in 5 -45 degree increments, or up to 180 degree increments. In some embodiments, the rotatable optical assembly resides in an annular recess of the lighting assembly. As described further herein, the rotatable optical assembly may comprise a rotatable support, disc or puck to which light source(s) and optic(s) of the assembly can be attached.

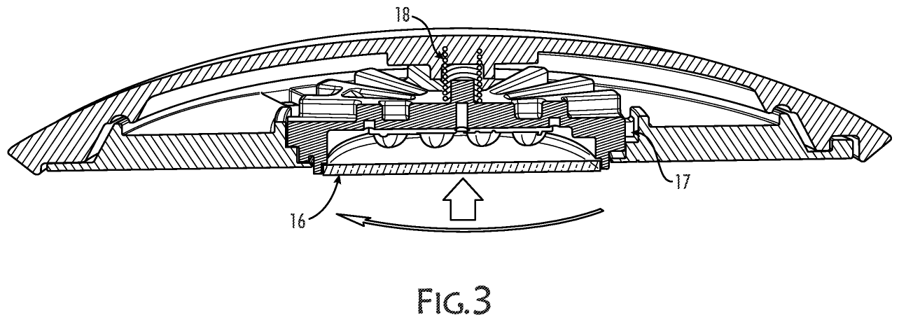

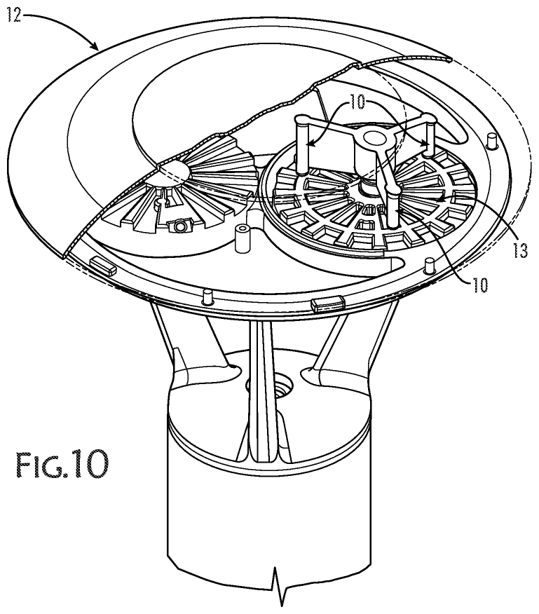

Moreover, rotational position of the rotatable optical assembly can be secured by a locking mechanism. Any desired locking mechanism can be employed. In some embodiments, the locking mechanism is mechanical. For example, the rotatable optical assembly can be depressed into a head space above the optical assembly. Depressing the optical assembly frees rotation of the optical assembly. Removal of the depressing force returns the optical assembly into a locked position in the annular recess. In some embodiments, the rotatable optical assembly can be coupled to a spring or other resistive mechanism establishing the need for a depressive force to move the optical assembly into the rotatable position. The spring or other resistive mechanism precludes rotation of the optical assembly in the absence of the depressive force. FIG. 3 illustrates a cut-away sectional view of a lighting assembly and associated rotatable optical assembly according to some embodiments. As illustrated in FIG. 3, the rotatable optical assembly 16 resides in an annular locking recess or pocket 17. Sides of the annular recess or pocket 17 can have one or more stops corresponding to the radial or angular adjustment increments of the rotatable optical assembly 16. Application of sufficient depressive force (here 2-5 lbs.) compresses the rotatable optical assembly 16 against the spring 18, thereby moving the optical assembly 16 vertically above the stops and into the rotatable position. The depressive force required to move the optical assembly 16 into the rotatable positon can be set to any desired value. In some embodiments, the depressive force is 2-10 lbs. The lighting assembly can also comprise hard stops in the head space above the annular locking recess or pocket 17. The hard stops can prevent the optical assembly from being dislodged from or misoriented within the pocket 17 during rotation. FIG. 10 illustrates one embodiment of hard stops 10 in the head space of the lighting assembly 12. The hard stops 10 are positioned over the rotatable optical element 13.

Alternatively, in some embodiments, the top cover of the lighting assembly or a panel on the top cover can be reversibly removed to expose the top of the rotatable optical assembly. The rotatable optical assembly can be subsequently rotationally adjusted by engaging the top side of the optical assembly. The optical assembly, for example, can have one or more structures for engaging with a rotational tool. In further embodiments, the rotatable optical assembly can be rotationally adjusted via electronic means employing one or more electric motors. In some embodiments, for example, the lighting fixture can comprise one or more processors or control systems and associated software for controlling rotational position of the rotatable optical assembly. In some embodiments, the lighting fixture comprises one or more electronic ports, such as USB ports, for interfacing with user control apparatus for adjusting rotational position of the rotatable optical assembly. In other embodiments, the lighting fixture comprises one or more sensors operable to receive remote signals for electronically adjusting the rotatable optical assembly. The one or more sensors may also be used to adjust other features of the lighting fixture including, but not limited to, luminance of the lighting fixture, color of the emitted light, and/or other operational features of the lighting fixture.

As used herein, the term “sensor” refers to any device configured to measure and/or detect events, conditions, or changes in its environment and generate an output. For example, in some cases, such sensors utilize transducers, piezoelectric materials, thermocouples, and/or various types of electrical circuitry components (e.g., capacitors or resistors) to detect events, conditions, or changes and convert the detected information into an electrical output. Exemplary sensors configured for use in lighting fixtures described herein include, without limitation, light sensors, motion sensors, image sensors, temperature sensors, magnetic field sensors, gravity sensors, humidity sensors, moisture sensors, vibration sensors, pressure sensors, electrical field sensors, sound or noise sensors, environmental sensors, directional sensors, position sensors, velocity sensors, airflow sensors, chemical sensors (i.e., sensors that detect toxins or chemical compounds, not limited to CO₂ sensors, oxygen O₂ sensors, etc.), electrical sensors (i.e., any sensor comprising electrical devices and/or any sensor that detects electrical events or conditions), or any combination thereof.

As used herein, the term “image sensor” refers to a device that detects, converts, and/or conveys data constituting an image. The sensor can detect light passing through and/or reflected by an object, convert the variations or attenuations of light into signals, and then convey the signals to a processing entity (e.g., a processor, controller, etc.). Image sensors described herein can detect electromagnetic radiation including, but not limited to infrared light, visible light, ultraviolet light, microwave radiation, or other types of radiation falling in the electromagnetic spectrum. Image sensors are used in electronic imaging devices such as cameras or camera modules. In some embodiments, image sensors described herein include, without limitation, cameras, semiconductor charge-coupled device (CCD) sensors, photodiode arrays, active pixel sensors having complementary metal-oxide semiconductor (CMOS) constructions, or N-type metal-oxide-semiconductor (NMOS, Live MOS) technologies.

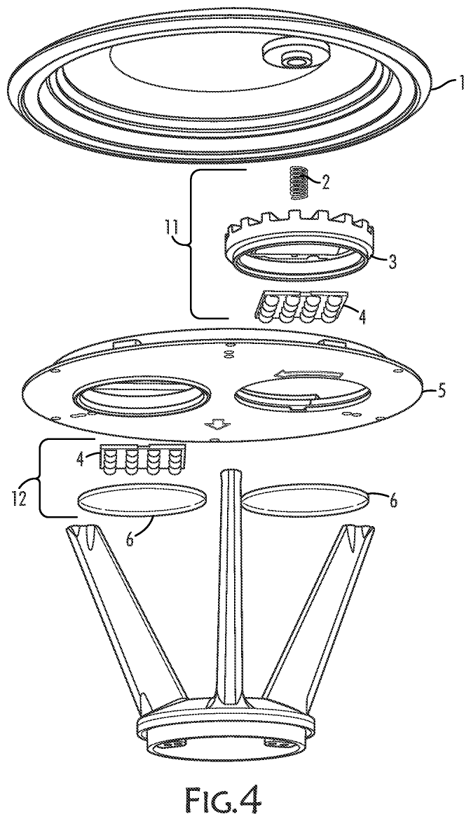

FIG. 4 illustrates an exploded view of a lighting assembly according to some embodiments. In the embodiment of FIG. 4, the lighting assembly 10 comprises a top cover 1, which engages a compression spring 2 for controlling rotational adjustment of the rotatable optical assembly 11, as described above. The rotatable optical assembly 11 comprises a rotatable disc or puck 3 to which light source(s) and optic(s) 4 of the assembly can be attached. The rotatable optical assembly 11 is positioned in a recess of a heatsink 5 of the lighting assembly 10. The heatsink 5 further comprises a second recess adjacent to the rotatable optical assembly 11. The adjacent recess houses the fixed optical assembly 12. The fixed optical assembly 12 also comprises light source(s) and optic(s) 4. Glass, polymeric, or other protective coverings 6 can be placed over the rotatable 11 and fixed 12 optical assemblies.

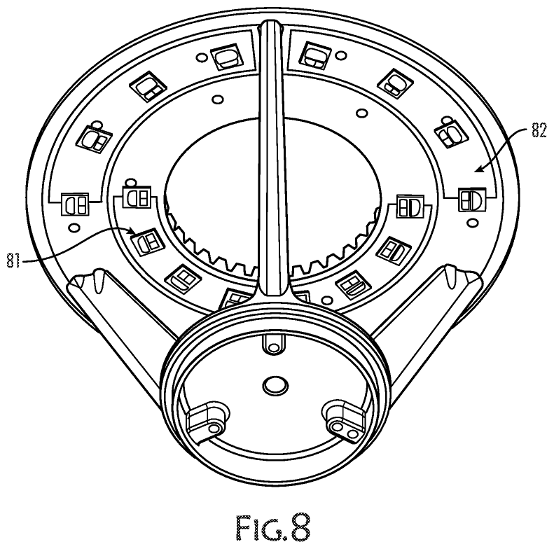

In the embodiments, for FIGS. 1-4, the fixed and rotatable optical assemblies have a circular profile and are arranged adjacent to one another. Any shape and arrangement of the fixed and rotatable optical assemblies are contemplated herein. In some embodiments, the fixed and rotatable optical assemblies are concentric or partially concentric with one another. The rotatable optical assembly may be within or partially within the circumference of the fixed optical assembly or vice versa. FIG. 8 illustrates one embodiment wherein the fixed and rotatable optical assemblies are in a semi-concentric format in the plane of the light emitting face. As illustrated in FIG. 8, the rotatable optical assembly 81 is arranged within the circumference of the fixed optical assembly 82. The rotatable optical assembly 81 is in an opposed position relative to the fixed optical assembly 82. The rotatable optical assembly 81 is operable to rotate to partially or fully adjacent to the fixed optical 82 assembly in a concentric manner. This format is reversible where the fixed optical assembly may be within the circumference of the rotatable optical assembly.

The fixed and rotatable optical assemblies can have the same profile or shape, such as circular illustrated in FIGS. 1-4 and arcuate, as illustrated in FIG. 8. Alternatively, the fixed and rotatable optical assemblies have different profiles or shapes. In some embodiments, the fixed optical assembly can be polygonal including, but not limited to, triangular, square, rectangular or hexagonal. The rotatable optical assembly may also adopt a polygonal profile or curved profile. Additionally, the light emitting face of a lighting assembly may comprise a plurality of rotatable optical assemblies and/or a plurality of fixed optical assemblies. The number, profiles and shapes of the fixed and rotatable optical assemblies can be chosen according to the lighting distributions to be provided by the light fixtures.

The fixed and rotatable optical assemblies can employ any desired light sources and optics. Specific identities of the light sources and associated optic(s) can be selected according to the desired lighting characteristics and distribution. In some embodiments, the light source comprises light emitting diodes (LEDs). The LEDs can have any desired arrangement, such as arrangement in one-dimensional arrays or two-dimensional arrays. In some embodiments, the LED light sources have an annular arrangement along the periphery or circumference of the fixed and/or rotatable optical assemblies. LED light sources may comprise packaged LED chip(s) or unpackaged LED chip(s). LED elements or modules can use LEDs of the same or different types and/or configurations. The LEDs, for example, can be monochromatic or any desired color combination. The LEDs can comprise single or multiple phosphor-converted white and/or color LEDs, and/or bare LED chip(s) mounted separately or together on a single substrate or package that comprises, for example, at least one phosphor-coated LED chip either alone or in combination with at least one color LED chip, such as a green LED, a yellow LED, a red LED, etc. The LED module can comprise phosphor-converted white or color LED chips and/or bare LED chips of the same or different colors mounted directly on a printed circuit board (e.g., chip on board) and/or packaged phosphor-converted white or color LEDs mounted on the printed circuit board, such as a metal core printed circuit board or FR4 board. In some embodiments, the LEDs can be mounted directly to a heat sink or another type of board or substrate. Depending on the embodiment, LED arrangements or lighting arrangements using remote phosphor technology can be employed as would be understood by one of ordinary skill in the art, and examples of remote phosphor technology are described in U.S. Pat. No. 7,614,759, which is hereby incorporated by reference.

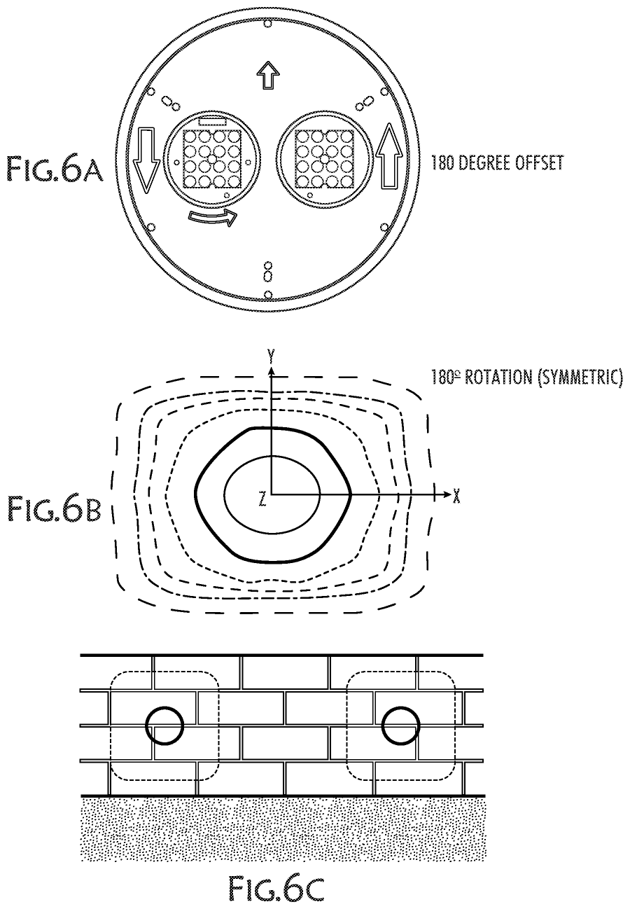

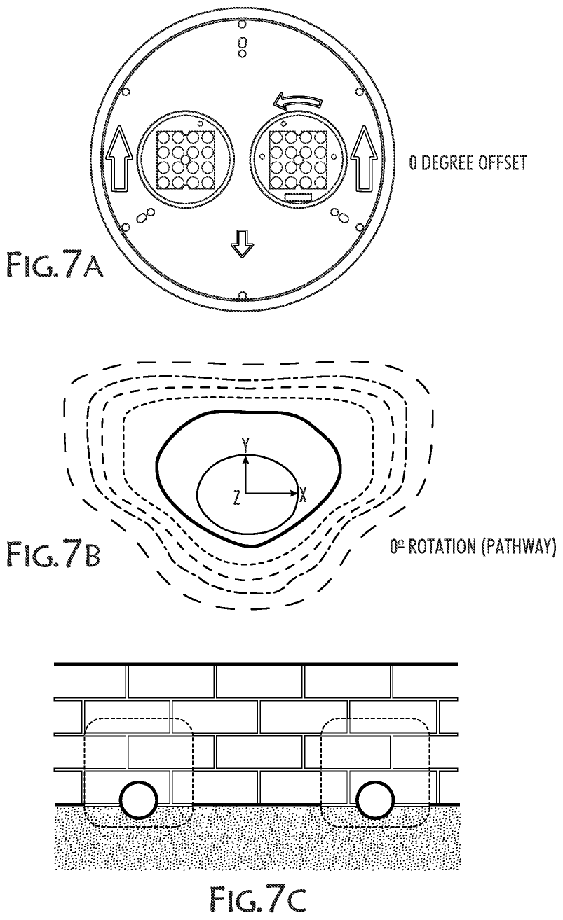

In those cases where a soft white illumination with improved color rendering is to be produced, each LED element or module or a plurality of such elements or modules may include one or more blue shifted yellow LEDs and one or more red or red/orange LEDs. Any color combination of LEDs in a module is contemplated. Additionally, The LEDs may be disposed in different configurations and/or layouts, as desired. Different color temperatures and appearances could be produced using other LED combinations of single and/or multiple LED chips packaged into discrete packages and/or directly mounted to a printed circuit board as a chip-on board arrangement. In one embodiment, the light sources can comprise any LED, for example, an XP-Q LED incorporating TrueWhite® LED technology. In some embodiments, color output of the fixed optical assembly and rotatable optical assembly can be the same or different. Color output of the fixed and rotatable optical assemblies can be the same, for example, when lighting the same areas, such as that illustrated in FIG. 7C herein. Color output of the fixed and rotatable optical assemblies can be different when lighting differing areas, such as that illustrated in FIG. 6C. Such color differentiation may be used to designate areas where standing or walking is permitted and areas where foot traffic should be avoided.

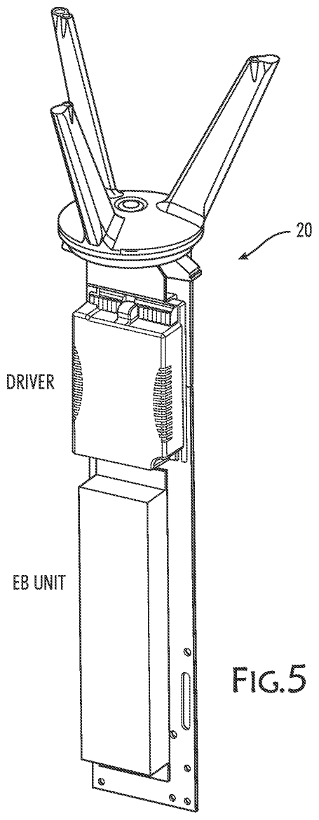

When LEDs are chosen as the light sources for the fixed optical assembly and/or rotatable optical assembly, the associated electronics, including driver(s), can be positioned in the support to which the lighting assembly is attached. Electrical circuity can extend from the support structure to the lighting assembly through one or more structural conduits, such as the arms coupling the lighting assembly to the second end of the support. FIG. 5 illustrates one embodiment where LED electronics are positioned in the support of the lighting fixture. Electrical circuitry, in some embodiments, can extend into the head space of the lighting assembly and access the back panels of the fixed and rotatable optical assemblies. The electrical circuitry has sufficient play to have unobstructed rotation with the rotatable optical assembly.

In addition to the light sources, the fixed and rotatable optical assemblies comprise optics associated with the light sources. Optics for the fixed assembly can be selected independently from or in conjunction with the optics for the rotatable assembly. A symmetric lighting distribution or asymmetric lighting distribution can be selected for each of the fixed optical assembly and rotatable optical assembly. In some embodiments, the fixed and rotatable optical assemblies have the same lighting distributions. Alternatively, the fixed and rotatable optical assemblies can have differing lighting distributions. In some embodiments, for example, each of the fixed and rotatable optical assemblies have a Type III or Type IV lighting distribution. In some embodiments, individual optics are provided for each of the light sources of the fixed and/or rotatable optical assemblies. For example, each LED in the assemblies may have an individual optical element. Alternatively, optics may be employed for groups of light sources in the fixed and/or rotatable optical assemblies. A single optic, for example, may be placed over the LEDs of the fixed or rotatable optical assembly. Optics of the fixed and rotatable optical assemblies can operate via refraction, reflection, and/or waveguiding/total internal reflection principles. Optics for the fixed and/or rotatable optical assemblies can comprise one or more waveguides, including the waveguides described in U.S. Pat. No. 11,249,239 which is incorporated herein by reference in its entirety.

The lighting distribution provided by the lighting assembly is a combination of the individual lighting distributions provided by the fixed optical assembly and the rotatable optical assembly. Therefore, the lighting distribution provided by the lighting assembly is adjustable according to the rotational position of the rotatable optical assembly. In some embodiments, the rotational position of the rotatable optical assembly is set to provide a symmetric lighting distribution from the lighting assembly. The rotational position of the rotatable optical assembly can also be set to provide an asymmetric lighting distribution from the lighting assembly. FIGS. 6A-6C illustrate one embodiment wherein the rotational position of the rotatable optical assembly is selected to provide a symmetric or substantially symmetric lighting distribution from the lighting assembly. In the embodiment illustrated by FIGS. 6A-6C, the fixed optical assembly and rotatable optical assembly each have an asymmetric lighting distribution, such as a Type III or Type IV distribution. FIG. 6A illustrates the light emitting face of the lighting assembly wherein the rotational position of the rotatable optical assembly is selected to direct the lighting distribution in a direction opposite of the fixed optical assembly. The 180 degree offset between the asymmetric lighting distributions of the fixed and rotatable optical assemblies provides a symmetric or substantially symmetric lighting distribution, as provided in FIG. 6B. The symmetric lighting distribution is further illustrated in FIG. 6C where the lighting fixtures are bollards lighting a pathway. The light emitting face of the lighting assembly faces the support and directs the lighting distribution to the ground surrounding the bollard.

In contrast, FIGS. 7A-7C illustrate one embodiment wherein the rotational position of the rotatable optical assembly is selected to provide an asymmetric lighting distribution form the lighting assembly. In the embodiment illustrated by FIGS. 7A-7C, the fixed optical assembly and rotatable optical assembly each have an asymmetric lighting distribution, such as a Type III or Type IV distribution. FIG. 7A illustrates the light emitting face of the lighting assembly wherein the rotational position of the rotatable optical assembly is selected to direct the lighting distribution in the same direction as that of the fixed optical assembly. The 0 degree offset between the asymmetric lighting distributions of the fixed and rotatable optical assemblies provides an asymmetric lighting distribution, as show in FIG. 7B. The asymmetric lighting distribution is further illustrated in FIG. 7C where the lighting fixtures are bollards lighting a pathway. In this embodiment, most of the light from the lighting fixtures is directed to the pathway and not the grass and/or landscaping areas behind the bollards. Moreover, the rotatable positon of the rotatable optical assembly can take additional positions between the 0 and 180 degree offsets illustrated in FIGS. 6A-6C and 7A-7C to provide a variety of lighting distributions from the lighting assembly.

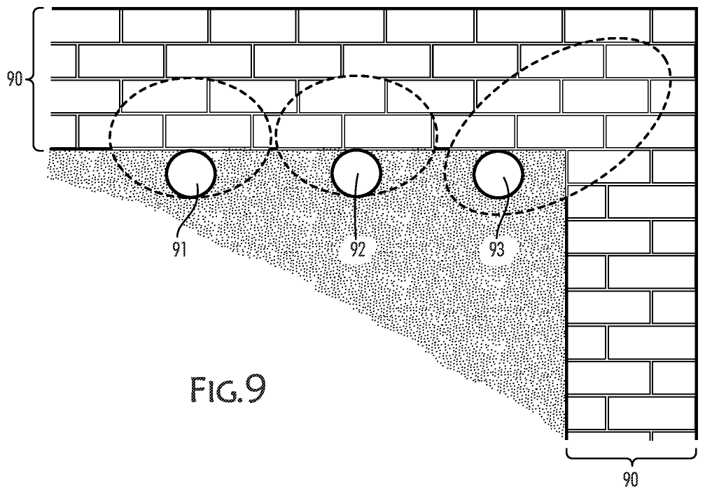

FIG. 9 illustrates another embodiment wherein the lighting fixtures or bollards have differing lighting distributions based on position or location of the bollards relative to the desired lighting area. In the embodiment of FIG. 9, the rotational position of bollards 91, 92 are selected to direct the lighting distribution in the same direction as the fixed optical asemblies, resulting in a Type IV distribution on the path 90. The rotational position of bollard 93 is selected to provide a Type III distribution in conjunction with the fixed optical assembly. Bollard 93 is positioned in the corner of the path 90, thereby requiring a differing lighting distribution.

Lighting fixtures described herein can be used in a variety of lighting applications. As illustrated in FIGS. 6C and 7C, the lighting fixtures can be bollards for pathway lighting. In some embodiments, the lighting fixtures can be employed for lighting walls, aisles and/or ceilings.

In another aspect, a lighting assembly of a lighting fixture comprises a light emitting face including at least one rotatable optical assembly, wherein the lighting distribution of the lighting assembly varies according to rotational position of the rotatable optical assembly. The rotatable optical assembly can have any architecture and/or properties described above. In some embodiments, the rotatable optical assembly has a construction and operation illustrated in FIGS. 3 and 4. Moreover, the light emitting face can comprise a plurality of rotatable optical assemblies, in some embodiments. Optics for the rotatable assemblies can be selected with reference to one another or independent of one another. The light emitting face may further comprise one or more fixed optical assemblies to work in conjunction with the rotatable optical assembly for providing the desired lighting distribution from the light emitting face. The one or more fixed optical assemblies can have any architecture and/or properties described above.

In another aspect, methods of lighting surfaces are described herein. A method, in some embodiments, comprises providing a lighting fixture including a support extending along an axis from a first end to a second end, and a lighting assembly coupled to the second end of the support, the lighting assembly having a light emitting face comprising a fixed optical assembly and a rotatable optical assembly, wherein the light emitting face faces the support. The rotational position of the rotatable optical assembly is adjusted to vary the lighting distribution directed to the surface by the lighting assembly. As described herein, the rotatable optical assembly can be adjusted to provide an asymmetric lighting distribution or a symmetric lighting distribution. In the present methods, the lighting fixture can have any properties, architecture and/or design described above and/or illustrated in the figures herein.

Various embodiments of the invention have been described in fulfillment of the various objectives of the invention. It should be recognized that these embodiments are merely illustrative of the principles of the present invention. Numerous modifications and adaptations thereof will be readily apparent to those skilled in the art without departing from the spirit and scope of the invention.

1. A lighting fixture comprising:
a support extending along an axis from a first end to a second end; and
a lighting assembly coupled to the second end of the support, the lighting assembly having a light emitting face comprising a fixed optical assembly and a rotatable optical assembly, wherein the light emitting face faces the support, and a lighting distribution of the lighting assembly varies according to the rotational position of the rotatable optical assembly.

2. The lighting fixture of claim 1, wherein the rotatable optical assembly provides an asymmetric lighting distribution.

3. The lighting fixture of claim 2, wherein the lighting distribution of the lighting assembly is substantially symmetric.

4. The lighting fixture of claim 1, wherein the fixed optical assembly and the rotatable optical assembly each have asymmetric lighting distributions.

5. The lighting fixture of claim 1, wherein the lighting distribution of the lighting assembly is asymmetric.

6. The lighting fixture of claim 1, wherein the rotatable optical assembly is rotatable in a plane parallel to the light emitting face.

7. The lighting fixture of claim 1, wherein the rotational position of the rotatable optical assembly is adjustable in 5-180 degree increments.

8. The lighting fixture of claim 1, wherein the rotational position of the rotatable optical assembly is secured by a locking mechanism.

9. The lighting fixture of claim 8, wherein the rotatable optical assembly is vertically displaceable to disengage the locking mechanism.

10. The lighting fixture of claim 1, wherein rotatable optical assembly comprises an array of light emitting diodes (LEDs) and one or more optical elements covering the LEDs.

11. The lighting fixture of claim 1, wherein lighting assembly is coupled to the second end of the support by one or more vertically extending arms.

12. A lighting assembly of a lighting fixture comprising:
a light emitting face including at least one rotatable optical assembly, wherein lighting distribution of the lighting assembly varies according to rotational position of the rotatable optical assembly.

13. The lighting assembly of claim 12, wherein the rotatable optical assembly provides an asymmetric lighting distribution.

14. The lighting assembly of claim 12, wherein the lighting distribution of the lighting assembly is asymmetric.

15. The lighting assembly of claim 12, wherein the rotatable optical assembly is rotatable in a plane of the light emitting face or a plane parallel to the light emitting face.

16. The lighting assembly of any of claim 12 further comprising on or more fixed optical assemblies.

17. A method of lighting a surface comprising:
providing a lighting fixture including a support extending along an axis from a first end to a second end, and a lighting assembly coupled to the second end of the support, the lighting assembly having a light emitting face comprising a fixed optical assembly and a rotatable optical assembly, wherein the light emitting face faces the support; and
adjusting rotational position of the rotatable optical assembly to vary the lighting distribution directed to the surface by the lighting assembly.

18. The method of claim 17, wherein the rotational position is adjusted to provide an asymmetric lighting distribution from the lighting assembly.

19. The method of claim 18, wherein the rotational position is adjusted to provide a symmetric lighting distribution from the lighting assembly.

20. The method of claim 18, wherein the lighting distribution is provided as a combination of the fixed optical assembly and rotatable optical assembly.
